(19) United States
(12) Patent Application Publication
(10) Pub. No.: US 2011/0215260 A1
(43) Pub. Date: Sep. 8, 2011

(54) Applicator means for radiation therapy as well as radiation therapy device

(76) Inventors: Timo Kleinwaechter, Muensingen (DE); Norman Roeder, Aalen (DE); Holger Fuchs, Aalen (DE); Frank Schneider, Mannheim (DE); Frederik Wenz, Heidelberg (DE)

(21) Appl. No.: 12/928,815

(22) Filed: Dec. 20, 2010

(30) Foreign Application Priority Data
Dec. 18, 2009 (DE) 10 2009 058 777.2

(51) Int. Cl. G21K 5/00; H01J 29/02

(52) U.S. Cl. 250/492.1; 250/522.1

(57) ABSTRACT

An applicator means (20) for radiation therapy, having at least one first applicator element for taking up a probe tip or a radiation source element (12) of a radiation source means (11), as well as a radiation therapy device (10) are described. In order to avoid an undesired slipping out of position of applicator means (20), particularly during the irradiation process, it is provided that the first applicator element is designed as an inner applicator element (21), which has a foot region (22), by means of which inner applicator element (21) can be attached to radiation source means (11), that applicator means (20) has a second applicator element which is designed as an outer applicator element (24) relative to inner applicator element (21), that outer applicator element (24) has an uptake space (28) for taking up at least one component of inner applicator element (21), and that inner applicator element (21) is designed so that it can be introduced into outer applicator element (24), at least in regions.

The present invention first of all relates to an applicator means for radiation therapy, having at least one first applicator element for taking up a probe tip or a radiation source element of a radiation therapy device. In addition, the invention also relates to a radiation therapy device.

The present invention, in particular, lies in the field of radiation therapy, and is particularly associated with the irradiation of tumors or the like.

Radiation therapy devices usually comprise a radiation source means, the operation of which gives rise to radiation, for example, x-ray radiation. The radiation that is generated is guided to the site to be irradiated by means of a probe tip or a radiation source element. For this purpose, so-called applicator means are generally used.

An applicator means, for example, comprises an applicator element, which is designed for taking up a probe tip or a radiation source element of a radiation therapy device. This means that the probe element or the radiation source element of the radiation therapy device is introduced, for example, inserted, into the applicator element. These types of applicator elements are already known in the prior art.

For example, an applicator means is described in Patent Application DE 10 2008 030 590 A1 of the Applicant, in which the applicator element provides a base body that comprises a number of different regions. A first region is formed by the foot region. It serves for taking up at least one component of a radiation therapy device, for example, at least one probe tip or one radiation source element, which represents one component of the radiation therapy device. A largely cylindrical guide region is adjacent to the foot region and this guide region serves for taking up and guiding a probe tip or a radiation source means. A transition region is provided between foot region and guide region. Finally, at its distal end, the applicator provides a head region, where, in particular, the radiation required for an irradiation is released.

In the operation of the radiation therapy device, radiation, for example, X-ray radiation, arises in the probe tip or in the radiation source element, and this radiation is released at least in the guide region of the applicator means. Using the applicator means, it can be achieved that body tissue can be directly irradiated at the site of a tumor.

The known applicator means is used in order to make possible an irradiation in very constricted body regions, in particular, in channels or ducts.

Cylindrical applicator means, however, may also serve for the purpose of irradiating body cavities. If an applicator means is designed cylindrically, for example, it can particularly serve for the purpose of irradiating body cavities that are shaped approximately cylindrically, such as, for example, the vagina or the rectum. In this case, a cylindrical applicator means is introduced into the body cavity. Then, in turn, a radiation source element is introduced into the applicator means and thus the target region is irradiated. Often also, the radiation source means delivers to different points in the applicator means in order to be able to irradiate a larger surface in this way. Delivery to different points has previously been conducted mostly by means of complex mechanisms. In addition, the danger exists that the applicator means can slip out of position, so that the desired region is no longer irradiated.

The object of the present invention is thus to further develop an applicator means of the type named initially so that an undesired slipping out of position of the applicator means, particularly during the irradiation process, can be avoided. In addition, a correspondingly improved radiation therapy device will be provided.

This object is achieved according to the invention by the applicator means with the features according to the independent patent claim 1, as well as the radiation therapy device with the features according to the independent patent claim 10. Additional features and details of the invention can be taken from the subclaims, the description and the drawings. Features and details, which are named in connection with the applicator means according to the invention, thus apply also, of course, in connection with the radiation therapy device according to the invention, and vice versa.

The present invention is based on the basic concept that the applicator means now has at least two applicator elements, wherein one applicator element is designed as an outer applicator element, while at least one other applicator element is designed as an inner applicator element, whereby the inner applicator element is disposed in the outer applicator element and is disposed therein particularly during the irradiation operation.

According to the first aspect of the invention, an applicator means is provided for radiation therapy, having at least one first applicator element for taking up a probe tip or a radiation source element of a radiation source means. The applicator means is characterized according to the invention in that the first applicator element is designed as an inner applicator element, that the applicator means has a second applicator element which is designed as an outer applicator element relative to the inner applicator element, that the outer applicator element has an uptake space for taking up at least one component of the inner applicator element, and that the inner applicator element is designed so that it can be introduced or is introducible into the outer applicator element, at least in regions.

In particular, it is also provided according to the invention that the inner applicator element has a foot region, by means of which the inner applicator element can be attached to the radiation source means. Thus, the inner applicator element can be attached and fixed to the radiation source means via its foot region.

An applicator means designed in this way is particularly suitable for accomplishing the named object. In particular, with such an applicator means, it is possible to prevent it from slipping out of position during the radiation operation, so that the disadvantages described initially can be avoided.

The applicator means according to the invention first of all comprises at least one applicator element that serves for the purpose of taking up a probe tip or a radiation source element of a radiation therapy device. According to the invention, this applicator element involves an inner applicator element. The inner applicator element is moved over a probe tip or a radiation source element.

Additionally, according to the present invention, it is now provided that the applicator means provides yet another applicator element. Here, this involves an applicator element that represents an outer applicator element relative to the inner applicator element. The applicator means according to the invention thus comprises an inner and an outer applicator element.

The outer applicator element can be introduced into a body cavity to be irradiated and then can be fixed, for example. Monitoring of whether the outer applicator element is placed in the correct position can be conducted by means of an examining method, for example, via ultrasound or x-rays. The inner applicator element, which has been moved over the probe tip or the radiation source element, is introduced into the outer applicator element. Subsequently, the radiation dose can be applied.

In order to take up the inner applicator element, the outer applicator element has an uptake space, which is designed for taking up at least one component of the inner applicator element. In addition, the inner applicator element is designed in such a way that it can be introduced into the outer applicator element, at least in regions, and is so introduced during the operation of the applicator means.

It is preferred that the inner applicator element has a foot region, by means of which the inner applicator element can be attached to the radiation source means. It is made possible in this way that the probe tip or the radiation source element and the inner applicator element can be moved jointly in the outer applicator element.

Preferably, the applicator means may involve an applicator means for radiotherapy. Advantageously, the applicator means can be used in connection with the irradiation of the vagina or the rectum, so that in such a case, the applicator means involves a vaginal applicator or a rectal applicator.

Basically, the invention is not limited to specific embodiments for applicator elements. It is only important that the inner applicator can be placed in the outer applicator so that the desired radiation dose can be brought in a targeted manner to the site of the irradiation. For example, the outer applicator element and/or the inner applicator element can be designed in a way such as was described above. In particular, it can be provided that the inner applicator element and the outer applicator element each have a cylindrical guide region and that the cylindrical guide region of the inner applicator element can be introduced into the cylindrical guide region of the outer applicator element.

Preferably, the applicator means can have a fastening means and/or a fixing means—in particular, a detachable fixing means. For example, it can be provided that the fastening means and/or the fixing means is/will be joined with the inner applicator element or the outer applicator element. After the outer applicator element has been inserted into the body cavity to be irradiated, it can be attached to the patient, for example, via the fastening means, and can be fixed in the desired position. For example, this can be accomplished by means of a suitable belt construction, whereby the invention is not limited to the named example. Advantageously, first the outer applicator element is introduced into the body cavity and is attached to the patient and fixed in place. Additionally, the correct positioning can be monitored, for example, by means of ultrasound or x-rays. After this, the inner applicator element is introduced into the outer applicator element.

Advantageously, the inner applicator element can be designed or disposed so that it can be moved and/or rotated in the outer applicator element. A configuration in which the inner applicator element can be moved in the outer applicator element, in particular, in the lengthwise direction, and/or in which the inner applicator element can be rotated in the outer applicator element, particularly has the advantage that additional radiation doses can also be applied at other sites. The outer applicator element does not need to be moved in this case. It suffices only that the inner applicator element and thus the radiation probe or the radiation source element found therein can be brought to the desired site by moving it thereto.

Advantageously, at least one spacer element can be provided for fixing the inner applicator element in a specific position. Such a spacer element is particularly of advantage if the inner applicator element is disposed or designed so that it can be moved in the outer applicator element. In this way, the distance to be set can be adjusted advantageously by means of this spacer element. For example, it can be provided that at least one spacer element is provided in the uptake space of the outer applicator element. If the outer applicator element has a foot region and a guide region, for example, it can be provided that at least one spacer element is provided in the foot region and/or in the guide region. In addition, it can be provided that the spacer element is provided in front of the outer applicator element, for example, in front of its introduction opening. Depending on the configuration in each case, it may be provided that at least one spacer element is provided in front of and/or in the outer applicator element.

The present invention is not limited to specific embodiments of spacer elements. Preferably, but not exclusively, the spacer element is shaped in such a way that it is unnecessary to remove the inner applicator element. In this way, the outer applicator element is prevented from slipping out of position. In order to achieve this, the spacer element can be designed or shaped, for example, as a semicircle or as a ⅝ circle.

In order to be able to apply different radiation doses to different sites, it can also be provided advantageously that the applicator means has two or more inner applicator elements with different lengths, particularly with different lengths of the cylindrical guide regions. In particular, if the outer applicator element is attached sufficiently solidly, so that one does not fear that it will slip out of position, such inner applicator elements with different lengths can be used. In comparison to an embodiment with spacer elements, such a configuration has the advantage that the inner applicator element and the outer applicator element can be guided while being held tightly in one another so that no air volume or, however, at least only a very small air volume arises or is present between the two applicator elements. In this way, an irradiation through uniform material and dosimetry can be simplified. Thus, it can advantageously also be provided that the outer surface of the inner applicator element lies against the inner surface of the uptake space of the outer applicator element, at least in regions, when it is introduced, particularly in the region where the radiation doses are delivered.

In another configuration, at least one insert element made of a material that protects against radiation can be provided in the uptake space of the outer applicator element, for shielding from radiation, at least in regions. Alternatively or additionally, it may be provided that the outer applicator element and/or the inner applicator element is/are formed from a material that protects against radiation, at least in regions, for shielding from radiation, at least in regions. In this case, the material that protects against radiation is incorporated directly in the outer applicator element or the inner applicator element. In this way, the outer applicator element or the inner applicator element can be modified by the material that protects against radiation, so that it no longer irradiates the entire surface, for example, the entire cylinder surface, but only a portion thereof. In this way, tissue that is not to be irradiated will be excluded from the irradiation. For example, a protection toward the front and/or laterally can be achieved in this way, depending on what is wanted and on the case of application. If the material that protects against radiation involves an insert in the outer applicator element, the insert can extend, for example, over the entire length of the outer applicator element, or, however, only partially in the outer applicator element. For example, such an insert can be designed as a component shaped like a segment of a circle, for example, as a semicircular tube. If the material that protects against radiation involves an insert, this insert advantageously can be disposed so that it can be moved and/or rotated in the outer applicator element. In this case, the invention is neither limited to a specific number of insert elements nor to a specific configuration of the insert elements, nor to a specific material that protects against radiation.

Preferably, the inner applicator element can be closed at its tip and/or the outer applicator element can be closed at its tip.

According to a second aspect of the invention, a radiation therapy device is provided, having a radiation source means, and having an applicator means for taking up a probe tip or a radiation source element of the radiation source means. The radiation therapy device is characterized in that a first applicator element of the applicator means is designed as an inner applicator element and that the applicator means has a second applicator element which is designed as an outer applicator element relative to the inner applicator element that the outer applicator element has an uptake space for taking up at least one component of the inner applicator element, and that the inner applicator element is designed so that it can be introduced into the outer applicator element.

In particular, it is also provided according to the invention that the inner applicator element has a foot region, by means of which the inner applicator element is attached or can be attached to the radiation source means.

The radiation therapy device can be used, in particular, for irradiating body cavities, for example, the vagina or the rectum.

The radiation therapy device first has a radiation source means, by means of which the radiation doses necessary for the irradiation will be produced. In particular, the radiation source means is designed for generating radiation for radiotherapy. The applicator means is disposed at the radiation source means.

Preferably, the applicator means is designed in the way according to the invention as described above, so that in this respect, reference is also made to the full content of the above statements relating to the applicator means.

Further, a radiation therapy device is preferred, in which a probe tip or a radiation source element of the radiation source means is provided in the inner applicator element, whereby the inner applicator element with the probe tip found therein or the radiation source element found therein is designed or disposed so that it can be moved and/or rotated in the outer applicator element.

The invention will now be explained in more detail on the basis of embodiment examples with reference to the appended drawings. Here:

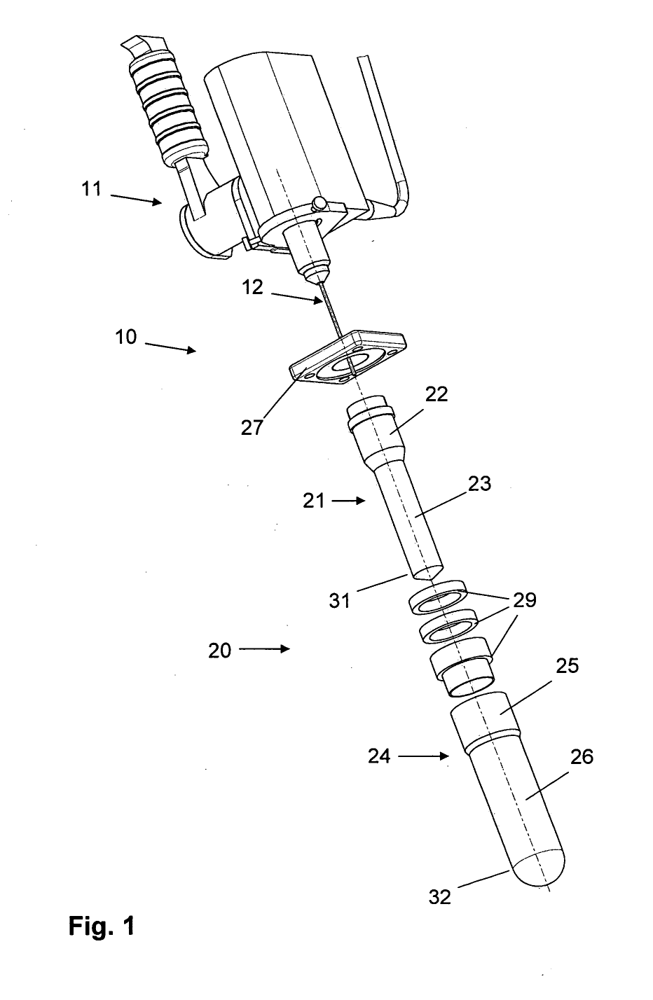

FIG. 1 is a perspective representation of individual components of the radiation therapy device according to the invention and the applicator means according to the invention;

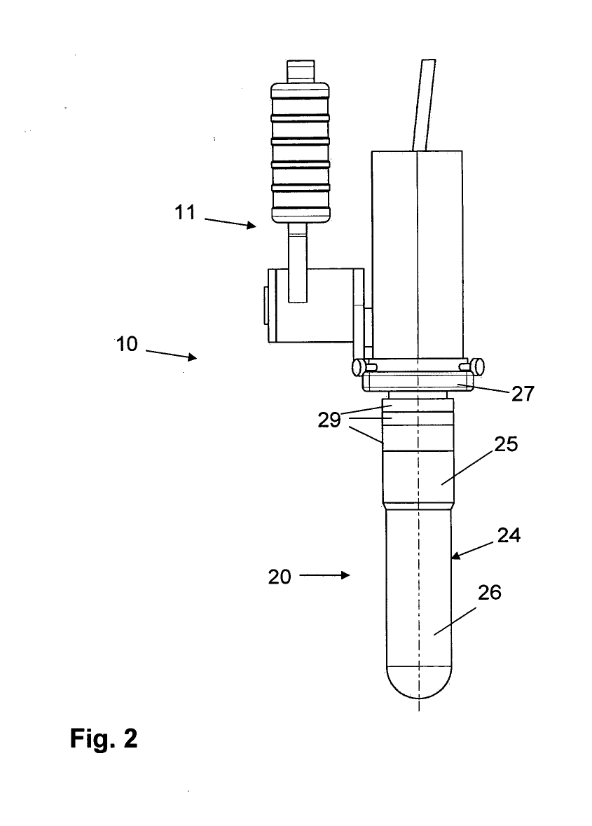

FIG. 2 is a representation of the radiation therapy device of the invention according to FIG. 1 in the assembled state; and

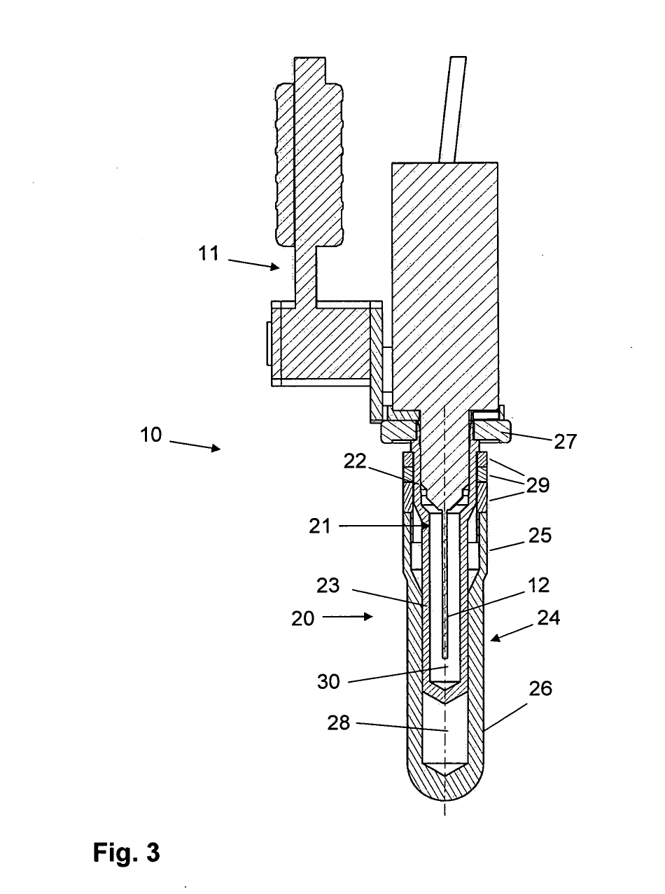

FIG. 3 is a sectional view of the radiation therapy device according to FIG. 2.

A radiation therapy device 10 according to the invention is shown in FIGS. 1 to 3. Radiation therapy device 10 has a radiation source means 11, which is designed, in particular, for generating radiation for radiotherapy. A radiation source element 12 is provided for applying the generated radiation.

In addition, an applicator means 20 according to the invention is shown in FIGS. 1 to 3. This is used for irradiating body cavities, for example, for irradiating the vagina or the rectum. Applicator means 20 first comprises an inner applicator element 21. The latter has a foot region 22 for taking up elements of radiation therapy device 10. In addition, inner applicator element 21 provides a cylindrical guide region 23 connecting to foot region 22. Additionally, applicator means 20 has an outer applicator element 24. Also, outer applicator element 24 has a foot region 25 and a cylindrical guide region 26 connecting thereto. In addition, applicator means 20 also provides a fastening and/or fixing means 27 for attaching to a patient. This means 27 can be a component of the outer applicator element 24 or of the inner applicator element 21, depending on the configuration. Additionally, spacer elements 29 are provided, which are found in the region of foot region 22 of inner applicator element 23 in the assembled state, as this is shown, in particular, in FIG. 3.

Inner applicator element 21 and outer applicator element 24 are closed at tips 31, 32.

Inner applicator element 21 is fastened to radiation source means 11 via its foot region 22. It is made possible in this way that radiation source element 12 and inner applicator element 21 can be moved jointly in outer applicator element 24.

In this way, inner applicator element 11 with radiation source element 12 found therein is designed or disposed so that it can be moved and/or rotated in outer applicator element 24.

Applicator means 20, which is shown in FIG. 1, is a component of radiation therapy device 10, which is shown in the assembled state in FIGS. 2 and 3. It is generally shown in FIG. 2 that radiation therapy device 10 comprises radiation source means 11, in which radiation, for example, radiation for radiotherapy, is produced. Applicator means 20 shown in FIG. 1 is disposed at radiation source means 11. How this can be accomplished in an advantageous manner is presented in connection with FIG. 3.

Applicator means 20 comprises inner applicator element 21 and outer applicator element 24. Outer applicator element 24 is introduced into a body cavity to be irradiated and attached to the patient by means of fastening means 27, for example, a belt construction, and is fixed in a specific position. Then one can monitor, for example, by means of ultrasound or x-rays, whether outer applicator element 24 is seated at the correct site.

Inner applicator element 21 is moved over a radiation source element 12 of radiation source means 11 and subsequently inserted into outer applicator element 24. In this case, inner applicator element 21 has an uptake space 30 for radiation source element 12, while a corresponding uptake space 28 for inner applicator element 21 is provided in outer applicator element 24. It is shown in FIG. 3 that foot region 22 of inner applicator element 21 is inserted into foot region 25 of outer applicator element 24 and that guide region 23 of inner applicator element 21 is inserted into guide region 26 of outer applicator element 24. The radiation doses are advantageously delivered, but only in the region of guide regions 23 and 26. Inner applicator element 21 and outer applicator element 24 may be or may become attached to radiation source means 11 by means of their respective foot regions 22, 25.

After introducing inner applicator element 21 into outer applicator element 24, the desired radiation dose can be applied. If another dose is to be applied at another site, inner applicator element 21 can be moved in the lengthwise direction, so that, in particular, guide region 23 of inner applicator element 21 is moved inside guide region 26 of outer applicator element 24.

If another dose is to be applied to another site, the inner applicator element 21 can be moved in the lengthwise direction. In this way, the distance to be set can be adjusted by means of spacer elements 29 that can be inserted. Spacer elements 29 are advantageously shaped so that it is not necessary to remove inner applicator elements 21. In this way, outer applicator element 24 is prevented from slipping out of position. In order to achieve this, spacer elements 29 can be designed, for example, as a semicircle or as a ⅝ circle.

Outer applicator element 24 can be modified by at least one insert of material that protects against radiation (not shown), so that it no longer irradiates the entire surface, for example, the entire cylinder surface, but only a portion thereof. In this way, tissue that is not to be irradiated is excluded from the irradiation. Alternatively or additionally, it may be provided that outer applicator element 24 and/or inner applicator element 21 is/are formed from a material that protects against radiation, at least in regions, for shielding from radiation, at least in regions.

### LIST OF REFERENCE SYMBOLS

10 Radiation therapy device
11 Radiation source means
12 Radiation source element
20 Applicator means
21 Inner applicator element
22 Foot region
23 Guide region
24 Outer applicator element
25 Foot region
26 Guide region
27 Fastening and/or fixing means
28 Uptake space of the outer applicator element
29 Spacer element
30 Uptake space of the inner applicator element
31 Tip of the inner applicator element
32 Tip of the outer applicator element

1. An applicator means for radiation therapy, having at least one first applicator element for taking up a probe tip or a radiation source element of a radiation source means, is hereby characterized in that the first applicator element is designed as an inner applicator element, which has a foot region, by means of which inner applicator element can be attached to radiation source means, that applicator means has a second applicator element which is designed as an outer applicator element relative to inner applicator element, that outer applicator element has an uptake space for taking up at least one component of inner applicator element, and that inner applicator element is designed so that it can be introduced into outer applicator element, at least in regions.

2. The applicator means according to claim 1, further characterized in that inner applicator element and outer applicator element each have a cylindrical guide region and that cylindrical guide region of inner applicator element can be introduced into cylindrical guide region of outer applicator element.

3. The applicator means according to claim 1, further characterized in that it has a fastening means and/or a fixing means.

4. The applicator means according to claim 1, further characterized in that inner applicator element can be designed or disposed so that it can be moved and/or rotated in outer applicator element.

5. The applicator means according to claim 1, further characterized in that at least one spacer element is provided for fixing inner applicator element in a specific position.

6. The applicator means according to claim 1, further characterized in that applicator means has two or more inner applicator elements with different lengths, particularly with different lengths of the cylindrical guide regions.

7. The applicator means according to claim 1, further characterized in that the outer surface of inner applicator element, after it has been introduced, lies against the inner surface of uptake space of outer applicator element.

8. The applicator means according to claim 1, further characterized in that at least one insert element made of material that protects against radiation is provided in uptake space of outer applicator element, for shielding from radiation, at least in regions, and/or that outer applicator element and/or inner applicator element is/are formed from a material that protects against radiation, at least in regions, for shielding from radiation, at least in regions.

9. The applicator means according to claim 1, further characterized in that inner applicator element is closed at its tip and/or outer applicator element is closed at its tip.

10. A radiation therapy device, having a radiation source means and having an applicator means for taking up a probe tip or a radiation source element of radiation source means, is hereby characterized in that a first applicator element of applicator means is designed as an inner applicator element, that inner applicator element has a foot region, by means of which inner applicator element is attached or can be attached to radiation source means, that applicator means has a second applicator element which is designed as an outer applicator element relative to inner applicator element, that outer applicator element has an uptake space for taking up at least one component of inner applicator element, and that inner applicator element is designed so that it can be introduced into outer applicator element.

11. The radiation therapy device according to claim 10, further characterized in that the inner applicator element and the outer applicator element each have a cylindrical guide region and that the cylindrical guide region of the inner applicator element can be introduced into the cylindrical guide region of the outer applicator element.

12. The radiation therapy device according to claim 10, further characterized in that a probe tip or a radiation source element of radiation source means is provided in inner applicator element, and that inner applicator element with the probe tip found therein or radiation source element found therein is designed or disposed so that it can be moved or rotated in outer applicator element.

13. The radiation therapy device according to claim 10, further characterized in that it has a fastening means and/or a fixing means.

14. The radiation therapy device according to claim 10, further characterized in that inner applicator element can be designed or disposed so that it can be moved and/or rotated in outer applicator element.

15. The radiation therapy device according to claim 10, further characterized in that at least one spacer element is provided for fixing inner applicator element in a specific position.

16. The radiation therapy device according to claim 10, further characterized in that applicator means has two or more inner applicator elements with different lengths, particularly with different lengths of the cylindrical guide regions.

17. The radiation therapy device according to claim 10, further characterized in that the outer surface of inner applicator element, after it has been introduced, lies against the inner surface of uptake space of outer applicator element.

18. The radiation therapy device according to claim 10, further characterized in that at least one insert element made of material that protects against radiation is provided in uptake space of outer applicator element, for shielding from radiation, at least in regions, and/or that outer applicator element and/or inner applicator element is/are formed from a material that protects against radiation, at least in regions, for shielding from radiation, at least in regions.

19. The radiation therapy device according to claim 10, further characterized in that inner applicator element is closed at its tip and/or outer applicator element is closed at its tip.
